(19) United States
(12) Patent Application Publication
(10) Pub. No.: US 2010/0060748 A1
(43) Pub. Date: Mar. 11, 2010

(54) IMAGE PICKUP APPARATUS AND IMAGE PICKUP CONTROL METHOD

(75) Inventor: Hitoshi Tsuchiya, Hamura-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/544,610

(22) Filed: Aug. 20, 2009

(30) Foreign Application Priority Data
Sep. 9, 2008 (JP) 2008-231264

(51) Int. Cl. H04N 5/228

(52) U.S. Cl. 348/222.1; 348/E05.031

(57) ABSTRACT

When an image of a subject formed by an optical system is picked up using an image pickup device, charges obtained upon receiving light for the subject image are accumulated with a time difference for each scan line in the image pickup device. Concurrently, a characteristic of the optical system is modified to change a distance to the subject at which the image pickup device is in focus, for each horizontal scan line.

### CROSS-REFERENCE TO RELATED APPLICATIONS

This application is based upon and claims the benefit of priority from prior Japanese Patent Application No. 2008-231264, filed Sep. 9, 2008, the entire contents of which are incorporated herein by reference.

### BACKGROUND OF THE INVENTION

1. Field of the Invention

The present invention relates to an image pickup apparatus taking images using perspective control without using a complicated optical mechanism of tilt-shift lens, and an image pickup control method for the image pickup apparatus.

2. Description of the Related Art

What is called view cameras such as large format cameras and medium format cameras are conventionally available. With the view cameras, images may be taken by a technique called tilt-shift image taking.

Images are normally taken with a positional relationship in which the optical axis of an image taking lens is orthogonal to a film surface. The tilt-shift image taking is an operation of intentionally changing the positional relationship in which the optical axis of the image taking lens is orthogonal to the film surface. With the tilt-shift image taking, even if for example, an image of a building is taken in such a manner that a photographer looks up at the building, special image taking can be achieved without causing distortion so that lower floors in the building appear to be as large as upper floors in the building and so that the building appears to stand straight.

For example, if an image of a train or the like is taken in an oblique direction, the distance from the image taking position to the head of the train is distance from the image taking position to the trail of the train. Even in this case, the tilt-shift image taking enables, for example, pan focus image taking in which all positions between the head and tail of the train are in focus. It should be noted here that a subject can be emphasized by decreasing the depth of field to be less than that corresponding to the optical characteristics of a lens.

For example, Jpn. Pat. Appln. KOKAI Publication No. 2005-292169 discloses a method of easily achieving image taking based on perspective control using a common digital single-lens reflex camera. Jpn. Pat. Appln. KOKAI Publication No. 2005-292169 includes an optical system guiding an image of a subject to an image pickup device. The optical system includes a first adjustment lens that is swingable around an axis of rotation orthogonal to the optical axis of the optical system, in a direction in which the optical axis of the lens is tilted, and a second adjustment lens located between the first adjustment lens and the image pickup device and which is movable in a direction orthogonal to the optical axis of the optical system. The optical system further includes detection means for detecting the amount by which the first adjustment lens is tilted around the axis, appropriate-value generation means for generating, according to the tilt amount detected by the detection means, an appropriate position along the orthogonal direction of the second adjustment lens at which position the image pickup device forms the best image, second adjustment lens moving means for moving the second adjustment lens in a direction orthogonal to the optical axis of the second adjustment lens, and control means for controlling the second adjustment lens moving means to move the second adjustment lens to the appropriate position. Thus, even when an optical path passing through the first adjustment lens shifts, Jpn. Pat. Appln. KOKAI Publication No. 2005-292169 allows the image pickup device to form proper images without the need for a complicated operation.

### BRIEF SUMMARY OF THE INVENTION

An image pickup apparatus according to a first aspect of the present invention comprises an image pickup device taking and converting a subject image formed by an optical system into a video signal, and optical adjustment section adjusting the optical system, and a control section generating one image data based on a video signal for the subject image captured by taking an image of one or a plurality of consecutive first line areas on horizontal scan lines in the image pickup device when the optical system is subjected to a first adjustment, and a video signal for the subject image captured by taking an image of a second line area adjacent to the first line area when the optical system is subjected to a second adjustment different from the first adjustment.

An image pickup control method for an image pickup apparatus according to a second aspect of the present invention comprises, when an image of a subject formed by an optical system is picked up using an image pickup device, accumulating charges obtained upon receiving light for the subject image, with a time difference for each horizontal scan line in the image pickup device, and modifying a characteristic of the optical system to change a distance to the subject at which the image pickup device is in focus, for each horizontal scan line.

### BRIEF DESCRIPTION OF THE SEVERAL VIEWS OF THE DRAWING

FIG. 1 is a diagram showing the configuration of a digital single-lens reflex camera as an example of an image pickup apparatus according to a first embodiment of the present invention;

FIG. 2 is a diagram showing the appearance of the camera;

FIG. 3 is a schematic diagram showing horizontal scan lines (accumulation lines) on an image formation surface of an image sensor in the camera;

FIG. 4 is a diagram showing a temporal relationship between charge accumulation and charge readout in the image sensor in the camera;

FIG. 5 is a diagram showing how a focus lens or a zoom lens group is moved when the camera is allowed to perform image taking similar to tilt-shift image taking;

FIG. 6 is a flowchart of tilt-shift image taking showing how the camera performs a tilt-shift image taking operation;

FIG. 7 is a diagram showing the configuration of a compact digital camera as an example of an image pickup apparatus according to a second embodiment of the present invention;

FIG. 8A is a front view showing the camera;

FIG. 8B is a rear view showing the camera;

FIG. 9 is a diagram showing the relationship between accumulation and readout during image taking by CCD in the camera;

FIG. 10 is a flowchart of tilt-shift image taking showing how the camera performs a tilt-shift image taking operation.

### DETAILED DESCRIPTION OF THE INVENTION

A first embodiment of the present invention will be described below with reference to the drawings.

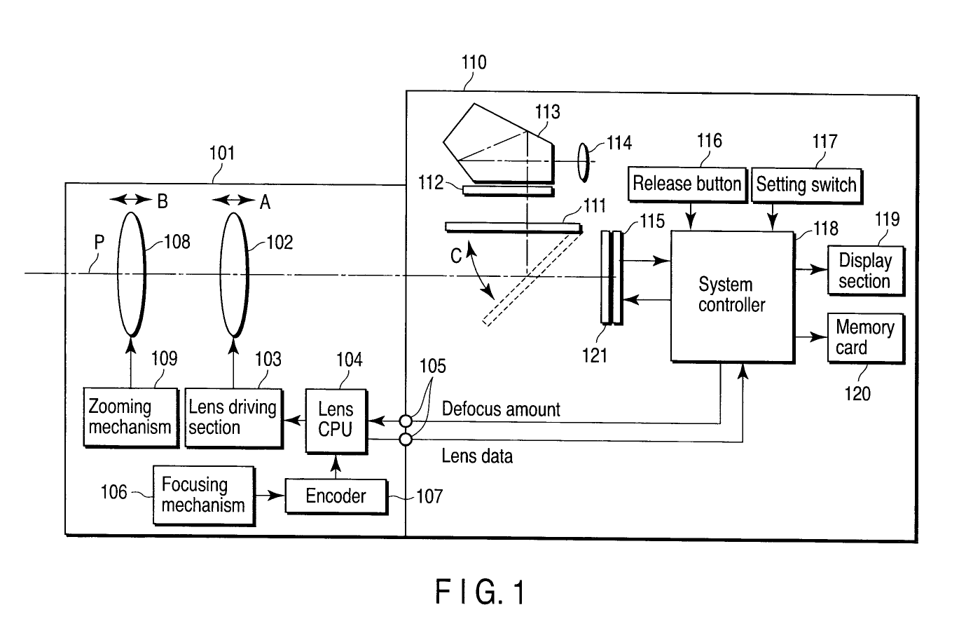

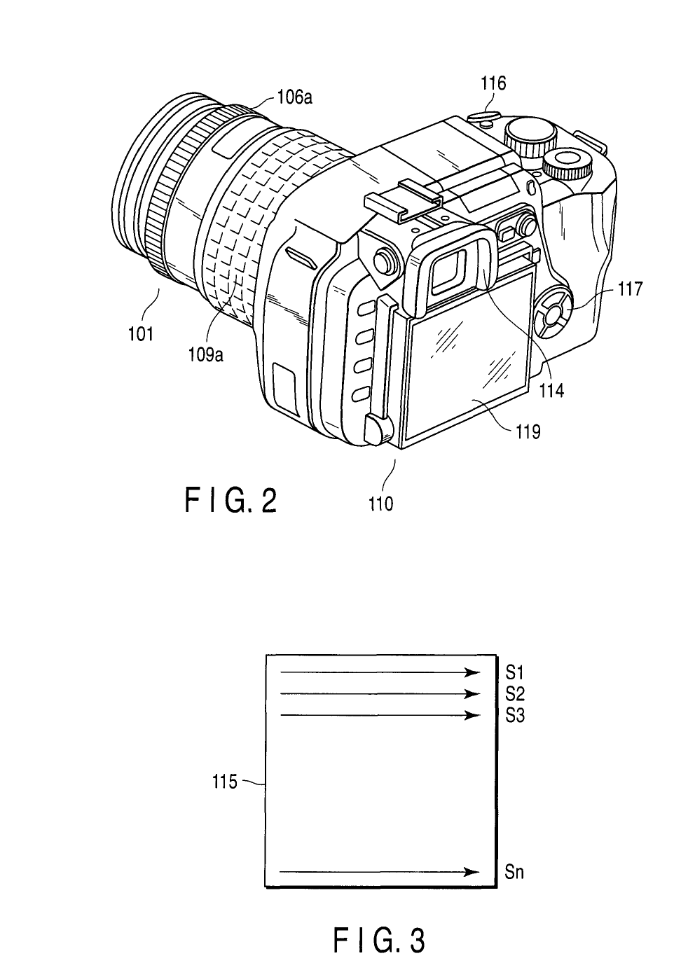

FIG. 1 is a diagram showing the configuration of a digital single-lens reflex camera as an example of an image pickup apparatus according to the first embodiment of the present invention. FIG. 2 is a diagram showing the appearance of the digital single-lens reflex camera. The present camera is composed of an interchangeable lens 101 and a camera body 110. The interchangeable lens 101 is provided via a camera mount provided on the front surface of the camera body 110. The interchangeable lens 101 is made up of a focus lens 102, a zoom lens group 108, a lens driving section 103, a lens CPU 104, a focusing mechanism 106, an encoder 107, and a zooming mechanism 109. The focusing mechanism 106 includes a focus ring 106a. The zooming mechanism 109 includes a zoom ring 109a.

The focus lens 102 and the zoom lens group 108 are arranged on an optical axis P. The focus lens 102 is for focusing. The focus lens 102 is moved in the same direction as that of the optical axis P (the direction of arrow A) by a lens driving section 103. The focus lens 102 moves to allow a luminous flux from a subject having passed through the zoom lens group 108 to be formed into a subject image on which the image pickup device 115 in a camera body 110 focuses.

The focusing mechanism 106 transmits an operation signal corresponding to a focusing operation by a user, to the encoder 107. That is, the focusing mechanism 106 transmits the operation signal corresponding to the user's operation of rotating the focus ring 106a. The encoder 107 receives an operation signal from the focusing mechanism 106 and outputs the amount of change by the focusing operation to the lens CPU 104 as an electric signal.

The zoom lens group 108 changes focal distance. The user operates the zooming mechanism 109 to allow the zoom lens group 108 to change the focal distance to a desired value. The zooming mechanism 109 moves the zoom lens group 108 in the same direction as that of the optical axis P (the direction of arrow B) in accordance with the user's operation of rotating the zoom ring 109a. Upon receiving the user's operation, the zooming mechanism 109 moves the zoom lens group 108 in accordance with the operation.

The lens CPU 104 counts electric signals from the encoder 107 to calculate the amount of change based on an operation performed on the focusing mechanism 106. The lens CPU 104 communicates data to and from a system controller 118 inside the camera body 110 via a communication connector 105. The lens CPU 104 transmits and receives various pieces of information such as camera characteristic information and defocus amount for autofocusing as well as various commands. The lens CPU 104 receives the amount of change based on an operation performed on the focusing mechanism 106 and the defocus amount from the system controller 118 inside the camera body 110, to drivingly control the lens driving section 103. The lens CPU 104 allows the lens driving section 103 to perform driving control so as to move the focus lens 102 in the direction of the optical axis P.

The lens driving section 103, the lens CPU 104, and the zooming mechanism 109 make up an optical adjustment section adjusting characteristics relating to the focus set by the focus lens 102 serving as an optical system or characteristics relating to the focal distance set by the zoom lens group 108.

On the other hand, the camera body 110 is made up of a main mirror 111, a focusing screen 112, a penta prism 113, an ocular 114, an image sensor 115, a release button 116, a setting switch 117, a system controller 118, a display section 119, a memory card 120, and a shutter 121.

The main mirror 111 is rotary movable in the direction of arrow C. During image taking, the main mirror 111 is positioned as shown by a solid line. During image taking, the main mirror 111 retracts from the luminous flux from the subject and transmits the subject image to the image sensor 115. During the periods other than that of image taking, the main mirror 111 is positioned as shown by a dashed line. During the periods other than that of image taking, the main mirror 111 reflects the luminous flux from the subject to form an image on a focusing screen 112.

The penta prism 113 allows the subject image formed on the focusing screen 112 to enter the ocular 114 as an image. The ocular 114 enlarges the subject image from the penta prism 113 so that the user can observe the subject image. Thus, the user can observe the subject's condition through the ocular 114.

The image sensor 115 functions as an image pickup device. The image sensor 115 takes and converts a subject image formed by the focus lens 102 serving as an optical system and the zoom lens group 108, into a video signal.

The release button 116 is depressed by the user to given an instruction to start image taking.

The setting switch 117 has some switches used to set an image taking mode, a shutter speed, and the like.

The display section 119 is made up of, for example, a liquid crystal display. The display section 119 displays videos obtained, information on the operation of the camera, and the like.

Image data captured by image taking is recorded in the memory card 120.

The shutter 121 is open during image taking so as to allow the image sensor 115 to form a subject image. While no image is taken, the shutter is closed to prevent the luminous flux from the subject from reaching the image sensor 115.

Now, control performed by the system controller 118 for image taking similar to tilt-shift image taking will be described.

The system controller 118 performs controllable focusing to move the focus lens 102 to a first adjustment position. At this time, an image of one or a plurality of consecutive first line areas on horizontal scan lines (accumulation lines) on an image formation surface of the image sensor 115 is taken to acquire a video signal for the subject image (hereinafter referred to as a first video signal for the subject image).

A predetermined time later, the system controller 118 performs controllable focusing to move the focus lens 102 to a second adjustment position different from the first adjustment position. At this time, an image of a second line area adjacent to the first line area is taken to acquire a video signal for the subject image (hereinafter referred to as a second video signal for the subject image).

Then, the system controller 118 generates one image data based on the first video signal for the subject image and the second video signal for the subject image.

The system controller 118 controls the image taking operation of the image sensor 115. The control allows the image sensor 115 to perform an image taking operation with a time difference between the first line area and the second line area on the plurality of horizontal scan lines on the image formation surface of the image sensor 115.

Specifically, charge accumulation and charge readout in the image sensor 115 will be described.

FIG. 3 is a schematic diagram of horizontal scan lines (accumulation lines) on the image formation surface of the image sensor 115. The image formation surface of the image sensor 115 has a plurality of horizontal scan lines S1, S2, . . . , Sn. The image sensor 115 starts accumulating charges obtained upon receiving the subject image, with a time difference for each of the respective horizontal scan lines S1, S2, . . . , Sn under the control of the system controller 118.

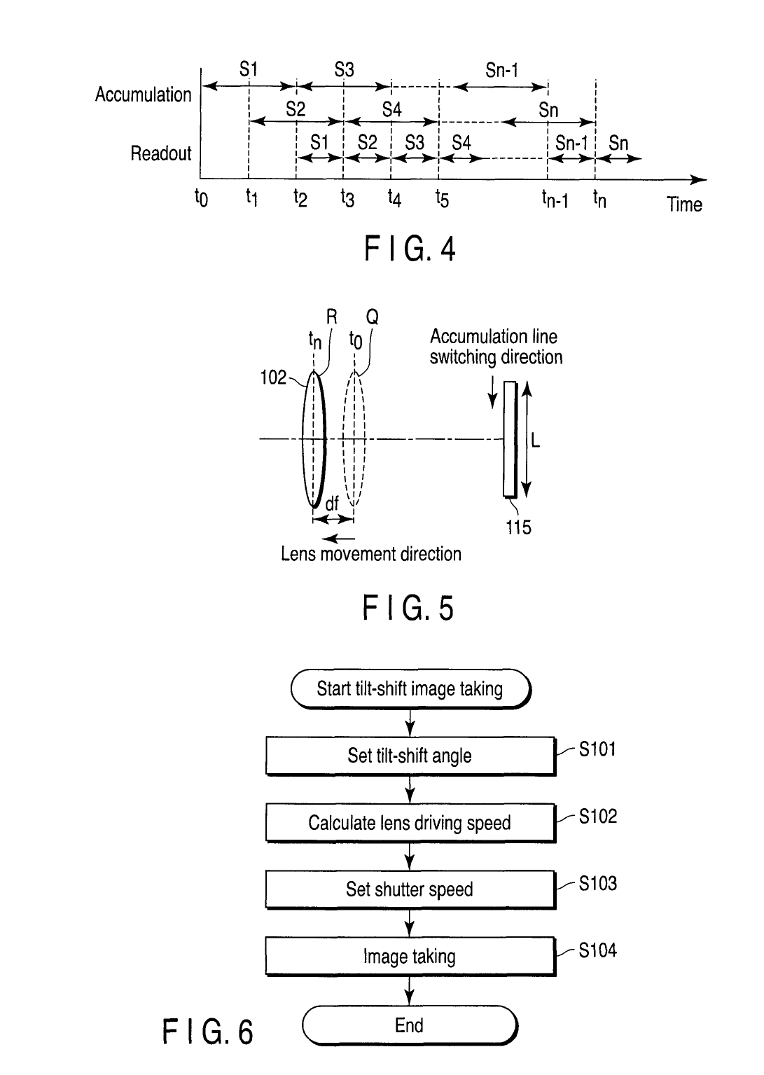

FIG. 4 shows an example of the temporal relationship between the charge accumulation and charge readout in the image sensor 115. The charge accumulation in the horizontal scan lines S1, S2, . . . , Sn is started at time t0 for the horizontal scan line S1. The charge accumulation in the horizontal scan line S1 lasts from time t0 until time t2. The charge accumulation time (between time t0 and time t2) varies with the brightness of the subject. The charge accumulation time (between time t0 and time t2) is determined based on a video signal from the image sensor 115.

Then, the charge accumulation in the horizontal scan line S2 is started at time t1, that is, a predetermined time (delay time) after time t0. The time difference is determined by subtracting time t1 from time t0. The charge accumulation in the horizontal scan line S2 lasts from time t1 until time t3.

Then, the charge accumulation in the horizontal scan line S3 is started at time t2, that is, a predetermined time after time t1. The time difference is the same as that between time t1 and time t0. The charge accumulation in the horizontal scan line S3 lasts from time t1 until time t4.

Similarly, the charge accumulation in each of the horizontal scan lines S3, S4, . . . , Sn is started at a point in time sequentially delayed by the delay time t1−t0 as a time difference.

The charges accumulated in the horizontal scan lines S1, S2, . . . , Sn are read out as follows.

At time t2, the readout of the charges accumulated in the horizontal scan line S1 is started. The readout of the charges accumulated in the horizontal scan line S1 is completed at time t3.

Then, at time t3, the readout of the charges accumulated in the horizontal scan line S2 is started. The readout of the charges accumulated in the horizontal scan line S2 is completed at time t4.

Then, at time t4, the readout of the charges accumulated in the horizontal scan line S3 is started. The readout of the charges accumulated in the horizontal scan line S3 is completed at time t5.

Similarly, the readout of the charges accumulated in each of the horizontal scan lines S3, S4, . . . , Sn is started at a point in time sequentially delayed by the delay time t1−t0 as a time difference.

The delay time t1−t0 is determined from a tilt-shift angle described below and a driving speed for the focus lens 102 with the minimum value of the delay time set equal to the readout time for each of the horizontal scan lines S3, S4, . . . , Sn. In the example shown in FIG. 4, the time required for the readout from each of the horizontal scan lines S3, S4, . . . , Sn is equal to the delay time t1−t0 between the horizontal scan lines S3, S4, . . . , Sn. Thus, the delay time t1−t0 corresponds to the minimum case.

The system controller 118 starts charge accumulation in the respective horizontal scan lines S1, S2, . . . , Sn at the corresponding points in time sequentially delayed by the delay time t1−t0. Concurrently, the system controller 118 moves the focus lens 102 as shown in FIG. 5 to vary the distance to the subject at which the subject is in focus, for each of the horizontal scan lines S1, S2, . . . , Sn. This allows image taking similar to tilt-shift image taking to be achieved. FIG. 5 shows a position Q observed at time t0 before the focus lens 102 is moved and a position R observed at time tn after the focus lens 102 has been moved.

The accumulation start time for the first horizontal scan line S1 and the accumulation end time for the final horizontal scan line Sn are defined as t0 and tn, respectively. As shown in FIG. 5, the distance between the first horizontal scan line S1 and the final scan line Sn on the image formation surface of the image sensor 115 is denoted as L. The amount by which the image formation surface of the image sensor 115 moves is defined as df. Then, a tilt-shift angle θ can be expressed by:

θ=tan⁻¹(df/L) (1)

Thus, the system controller 118 generates one image data with the tilt-shift angle θ expressed by Equation (1).

When the time required to move the focus lens 102 from the position Q to the position R is defined as Tdf, the system controller 118 determines the delay time t1−t0 so that the following relationship is established (time difference changing section).

t1−t0=Tdf/n (2)

Thus, the time difference (delay time t1−t0) can be adjusted to a predetermined value corresponding to the tilt-shift effect.

When the time difference (delay time t1−t0) is set, the image sensor 115 starts charge accumulation with the time difference set for each of the horizontal scan lines S1, S2, . . . , Sn, to perform an image taking operation.

The system controller 118 generates one image data from a video signal for one image picked up by the image sensor 115.

The setting switch 117 is used to set the amount by which the focus lens 102 needs to move during image taking.

The system controller 118 moves the focus lens 102 in the direction of arrow A over time based on the movement amount of the focus lens 102 set via the setting switch 117.

Now, the operation of tilt-shift image taking by the camera configured as described above will be described according to the flowchart of tilt-shift image taking shown in FIG. 6.

First, the user operates the setting switch 117 to select the tilt-shift image taking mode. When the tilt-shift image taking mode is selected, the system controller 118 starts a tilt-shift image taking operation. Once the tilt-shift image taking operation is started, the main mirror 111 is turned upward. Concurrently, the shutter 121 is opened and the system controller 118 shifts to a live view mode.

In the live view mode, a subject image formed by the image sensor 115 is displayed on the display section 119 via the system controller 118 in real time. The user operates the setting switch 117 to input the tilt-shift image taking angle θ while checking the subject image displayed on the display section 119 in real time. In step S101, the system controller 118 receives the tilt-shift angle θ from the setting switch 117 to set the angle θ.

In step S102, the system controller 118 calculates Equation (1) described above from the tilt-shift angle θ to determine the lens driving amount by which the focus lens 102 is driven in the direction of arrow A. The system controller 118 further determines the driving speed for the focus lens 102.

The system controller 118 determines the driving time from the lens driving amount and the driving speed for the focus lens 102. The system controller 118 determines the delay time t1−t0 from the driving time based on Equation (2) described above.

Then, in step S103, the system controller 118 determines shutter speed based on a video signal read out from the image sensor 115. The shutter speed does not indicate the duration from opening until closing of the shutter 121 but the duration from the accumulation start time t0 until the accumulation end time tn in the image sensor 115.

In the present embodiment, the image sensor 118 sets, for example, the delay time t1−t0 for the accumulation start time for each the horizontal scan lines S1, S2, . . . , Sn. Thus, the image sensor 118 performs operations equivalent to those of what is called a rolling shutter. The shutter speed is determined based on exposure time for each of the horizontal scan lines S1, S2, . . . Sn, the delay time t1−t0 between the horizontal scan lines S1, S2, . . . , Sn, and the number of the horizontal scan lines S1, S2, . . . , Sn for the image sensor 118.

When the user depresses the release button 116, then in step S104, the system controller 118 starts controlling an image taking operation. As described above, in the image taking operation, the system controller 118 performs control such that charges are accumulated with the delay time t1−t0 for each of the horizontal scan lines S1, S2, . . . , Sn as shown in FIG. 4. Concurrently, as shown in FIG. 5, for example, the focus lens 102 is moved at the driving speed for the focus lens 102 determined in step S102. Thus, the distance to the subject at which the subject is in focus varies for each of the horizontal scan lines S1, S2, . . . , Sn. As a result, images are taken under an effect similar to tilt-shift image taking.

Thus, according to the above-described first embodiment, in a normal digital single-lens reflex camera, charges are accumulated with the delay time t2−t1 for each of the horizontal scan lines S1, S2, . . . , Sn in the image sensor as shown in FIG. 4. Concurrently, as shown in FIG. 5, for example, the focus lens 102 is moved to vary the distance to the subject at which the subject is in focus, for each of the horizontal scan lines S1, S2, . . . , Sn. As a result, image data exhibiting an effect equivalent to tilt-shift image taking can be captured. This enables the configuration of a normal digital single-lens reflex camera to exert the tilt-shift image taking effect without the need for a particular complicated mechanism.

Image taking is performed with the focus position varied for each of the horizontal scan lines S1, S2, . . . Sn in the image sensor 115. Thus, the focus position varies for each of the horizontal scan lines S1, S2, . . . Sn for the image data. This effectively enables pan focus image taking or allows the subject to be emphasized.

The setting switch 117 is operated to set the tilt-shift angle θ. Thus, based on the set tilt-shift angle θ, the duration of image taking and the amount by which the focus lens 102 is adjusted are determined. The user can adjust the tilt-shift amount according to the subject's condition.

During the tilt-shift image taking, the user turns the zoom lens 109a as in the case of zoom burst. This allows exertion of an effect similar to perspective control based on tilt-shift.

Now, Zoom burst will be described. Zoom burst is to operate the zoom ring 109a to move the zoom lens 108 while the image sensor 115 is exposed, thus varying the focal distance. The zoom burst provides a unique image in which the subject extends radially from the center of an image taking field. This effect is exerted because the image taking field is concurrently taken. In the present embodiment, the image sensor 115 performs operations equivalent to those of a rolling shutter. The focal distance varies according to a shutter direction, thus allowing exertion of an effect similar to perspective control based on tilt-shift.

Now, a second embodiment of the present invention will be described.

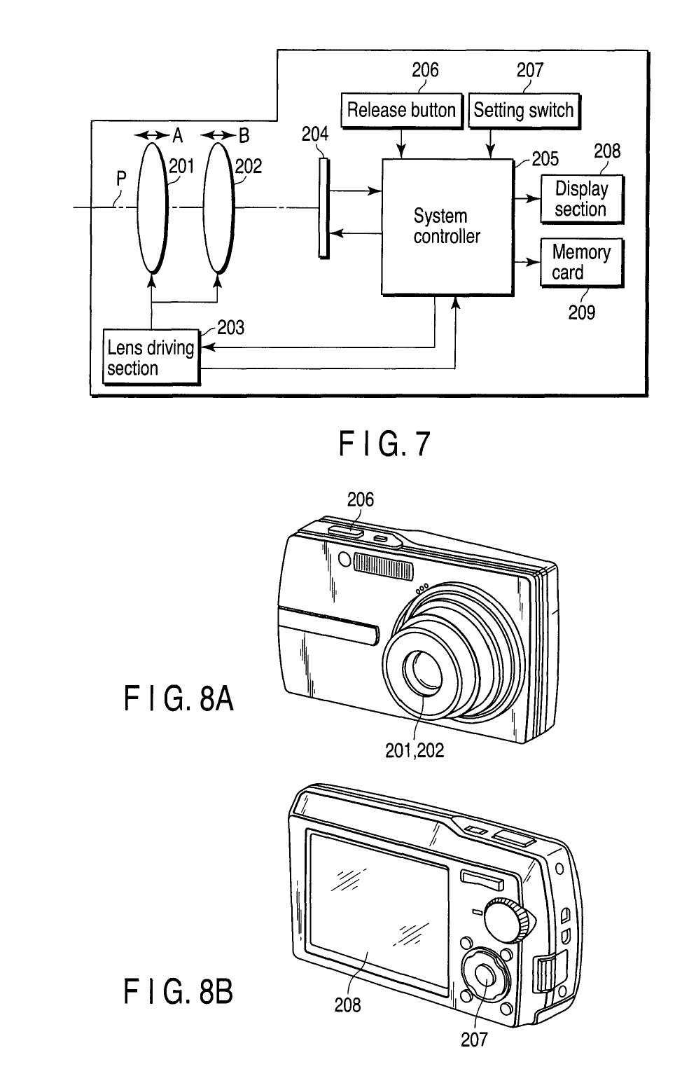

FIG. 7 is a diagram showing the configuration of a compact digital camera as another example of the image taking apparatus according to the embodiment of the present invention. FIG. 8A and FIG. 8B are diagrams showing the appearance of the compact digital camera. FIG. 8A is a front view. FIG. 8B is a rear view.

The present camera includes a focus lens 201, a zoom lens 202, a lens driving section 203, CCD 204 as an image taking device, a system controller 205, a release button 206, a setting switch 207, a display section 208, and a memory card 209.

The focus lens 201 moves in the same direction as that of an optical axis P. The focus lens 201 adjusts the focus of a subject image to be formed on CCD 204.

The zoom lens group 202 is made up of a plurality of lenses. The zoom lens group 202 changes the focal distance to switch the image scaling factor of the subject image to be formed on CCD 204.

The lens driving section 203 is composed of, for example, a stepping motor. The lens driving section 203 drivingly moves the focus lens 201 in the direction of arrow A, in the same direction as that of the optical axis P, based on driving pulses provided by the system controller 205. Thus, the zoom lens group 202 is moved in the direction of arrow B, in the same direction as that of the optical axis P.

CCD 204 converts the subject image formed through the focus lens 201 and the zoom lens group 202 into an electric signal. CCD 204 receives control signals from the system controller 205 to read out electric signals for the subject image as image data.

The setting switch 207 has some switches used to set an image taking mode and various functions for the camera.

When depressed by the user, the release button 206 transmits an image taking instruction to the system controller 205. When the user operates the setting switch 207 while checking a menu displayed on the display section 208, the system controller 205 determines the operation mode of the camera. When the user operates the setting switch 207 while checking the menu displayed on the display section 208, the system controller 205 sets the image taking mode, the tilt-shift angle, and the like.

The display section 208 is made up of, for example, a liquid crystal display. The display section 208 displays image taking data and menu screens output by the system controller 205.

Image data obtained is recorded in the memory card 209.

Now, control performed by the system controller 205 for image taking similar to tilt-shift image taking will be described.

The system controller 205 generates one image data by extracting, from video signals for a plurality of images picked up by CCD 204, a video signal captured by taking an image of a first line area corresponding to a first image and a video signal captured by taking an image of a second line area corresponding to a second image.

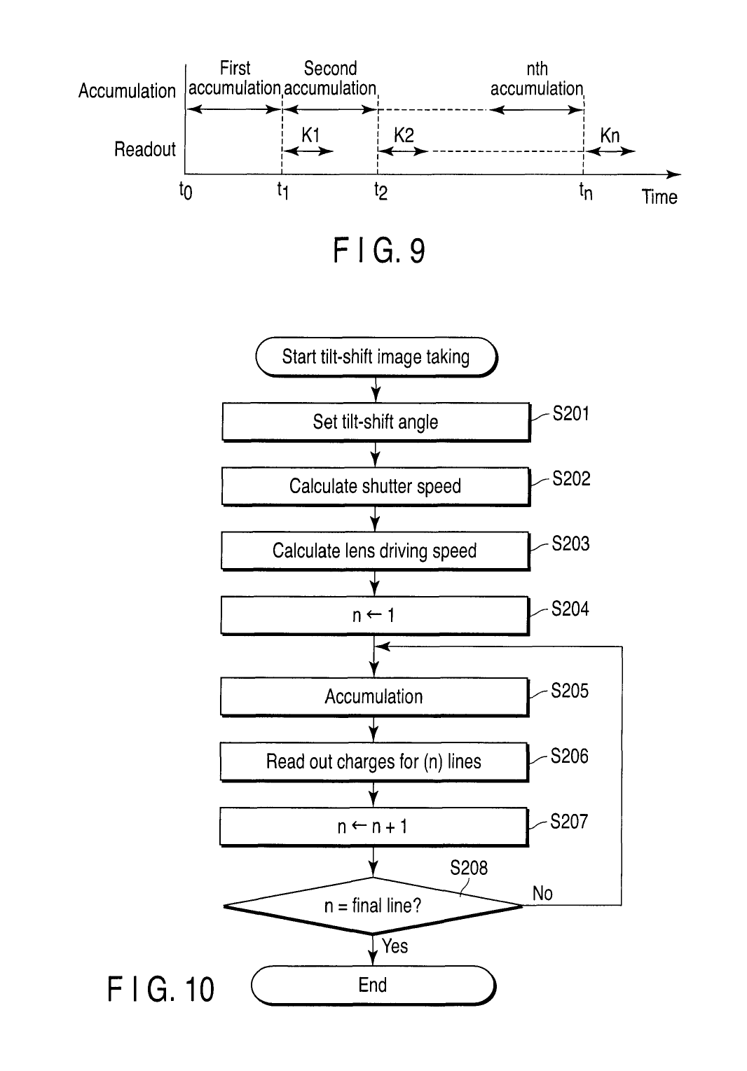

FIG. 9 shows the relationship between accumulation and readout during image taking by CCD 204. The first charge accumulation in CCD 204 using all horizontal scan lines K1, K2, . . . , Kn lasts from time t0 until time t1. After the first accumulation, charges are read out only from the horizontal scan line K1. Readout of the charges accumulated during the first accumulation is started at time t1.

Then, in parallel with the readout from the horizontal scan line K1 starting at time t1, the second charge accumulation is started using all the horizontal scan lines K1, K2, . . . , Kn in CCD 204. The second charge accumulation lasts until time t2. After the second accumulation, charges are read out only from the horizontal scan line K2. Readout of the charges accumulated during the second accumulation is started at time t2.

Similarly, each of the subsequent steps involves accumulation using all the horizontal scan lines K1, K2, . . . , Kn in CCD 204 and readout of accumulated charges from each of the horizontal scan lines K3, K4, . . . , Kn.

The accumulation time t1−t0 varies with the brightness of the subject. The accumulation time t1−t0 is determined based on the video signal from CCD 204. The readout time needs to be shorter than the accumulation time. Thus, the shortest accumulation time is equal to the readout time for the horizontal scan line.

The charges are read out from each of the horizontal scan lines K1, K2, . . . , Kn. However, the readout may be performed on a plurality of lines at a time.

The system controller 205 reads out charges with a time difference for each of the horizontal scan lines K1, K2, . . . , Kn in CCD 204. Concurrently, for example, the system controller 205 moves the focus lens 201 in the direction of arrow A. Thus, the distance to the subject at which the subject is in focus is varied for each of the horizontal scan lines K1, K2, . . . , Kn to allow image taking similar to tilt-shift image taking to be performed.

The system controller 205 generates one image data by extracting, from video signals for a plurality of images picked up by CCD 204, a video signal captured by taking an image of a first line area corresponding to a first image, for example, the horizontal scan line K1, and a video signal captured by taking an image of a second line area corresponding to a second image, for example, the horizontal scan line K2. In this case, in taking a plurality of images, CCD 204 takes the first image through the first line area and converts the image into a video signal. CCD 204 then takes the second image through the second line area and converts the image into a video signal.

Now, the operation of tilt-shift image taking by the camera configured as described above will be described according to the flowchart of tilt-shift image taking shown in FIG. 10.

First, the user operates the setting switch 207 to select the tilt-shift image taking mode. When the tilt-shift image taking mode is selected, the system controller 205 starts a tilt-shift image taking operation. CCD 204 converts a formed subject image into an electric signal. The system controller 205 displays the subject image from CCD 204 on the display section 208 in real time.

The user operates the setting switch 207 to input the tilt-shift image taking angle θ while checking the subject image displayed on the display section 208 in real time. In step S201, the system controller 205 receives the tilt-shift angle θ from the setting switch 207 to set the angle θ.

Then, in step S202, the system controller 205 determines the shutter speed based on the video signal output by CCD 204. The shutter speed is determined from the accumulation time for each of the horizontal scan lines K1, K2, . . . , Kn and the number of the horizontal scan lines K1, K2, . . . , Kn. The shutter speed can be reduced by adopting a scheme of reading out charges from a plurality of lines at a time.

The system controller 205 determines, based on the set tilt-shift angle θ, whether the plurality of horizontal scan lines K1, K2, . . . , Kn fall within the range of a focal depth. Upon determining that the plurality of lines fall within the range of the focal depth, the system controller 205 controllably accumulates charges in a plurality of lines at a time. That is, a larger tilt-shift angle θ reduces the number of the plurality of lines that are controllable at a time. A smaller tilt-shift angle θ increases the number of the plurality of lines that are controllable at a time.

Then, in step S203, as in the case of the above-described first embodiment, the system controller 205 calculates Equation (1) described above based on the tilt-shift angle θ and the shutter speed, corresponding to the time from the accumulation start time t0 until the accumulation end time tn of the CCD 204, to determine the lens driving amount by which the focus lens 201 is driven in the direction of arrow A. The system controller 205 further determines the driving speed for the focus lens 201.

To change the focal distance, the system controller 205 determines the lens driving amount by which the zoom lens group 202 is driven in the direction of arrow B as well as the driving speed for the zoom lens group 202. In this case, the lens driving amount may be calculated by replacing the change amount dF of the focus with the defocus amount df with reference to Equation (1).

Then, in step S204, the system controller 205 initializes the number (n) of lines (n←1). Then, in step S205, the system controller 205 starts accumulating charges in CCD 204. At this time, charges are simultaneously accumulated in all the horizontal scan lines K1, K2, . . . , Kn.

Then, when the charge accumulation in the horizontal scan lines K1, K2, . . . , Kn in CCD 204 is completed, then in step S206, the system controller 205 reads out charges accumulated in a predetermined horizontal scan line indicated by (n). To allow the charges accumulated in the horizontal scan lines K1, K2, . . . , Kn to be read out, first, the readout of the charges from the horizontal scan line K1 is started at time t1. Then, the readout of the charges from the horizontal scan line K2 is started at time t2. The readout of the charges from each of the horizontal scan lines K3, K4, . . . , Kn is similarly performed following the completion of the accumulation.

Then, in step S207, the system controller 205 adds to the number (n) of lines (n←n+1). In this case, “1” is added to the number (n) of lines. However, the present invention is not limited to this aspect but any number larger than “1” may be added. For example, if a plurality of lines are controlled at a time, the number of these lines is added.

Then, in step S208, the system controller 205 determines whether or not the horizontal scan line from which the charges are read out has reached the final horizontal scan line Kn. Upon determining that the final horizontal scan line Kn has been reached, the system controller 205 ends the image taking.

As described above, according to the second embodiment, the charges are read out with the time difference for each of the horizontal scan lines K1, K2, . . . , Kn, while for example, the focus lens 201 is moved in the direction of arrow A. Thus, the distance to the subject is varied for each of the horizontal scan lines K1, K2, . . . , Kn to enable image taking exhibiting an effect equivalent to tilt-shift image taking. Consequently, the second embodiment can exert effects similar to those of the above-described first embodiment.

The zoom lens group 202 is moved in the direction of arrow B. Thus, an image exhibiting an effect which is similar to perspective control based on tilt-shift image taking and under which the focal distance varies for each of the horizontal scan lines K1, K2, . . . , Kn.

As described above, the present invention allows the configuration of a normal compact digital camera to exert the tilt-shift image taking effect without the need for a particular complicated optical mechanism of tilt-shift lens.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image pickup apparatus comprising:
an image pickup device taking and converting a subject image formed by an optical system into a video signal;
an optical adjustment section adjusting the optical system; and
a control section generating one image data based on the video signal for the subject image captured by taking an image of one or a plurality of consecutive first line areas on horizontal scan lines in the image pickup device when the optical system is subjected to a first adjustment, and the video signal for the subject image captured by taking an image of a second line area adjacent to the first line area when the optical system is subjected to a second adjustment different from the first adjustment.

2. The image pickup apparatus according to claim 1, wherein the image pickup device performs the image taking operation with a time difference between the first line area and the second line area.

3. The image pickup apparatus according to claim 2, wherein the image pickup device sets the time difference based on an exposure time for the first line area.

4. The image pickup apparatus according to claim 2, further comprising:
a time difference changing section changing the time difference,
wherein the image pickup device performs the image pickup operation with the time difference changed by the time difference changing section.

5. The image pickup apparatus according to claim 1, wherein the control section generates one image data from the video signal for one image picked up by the image pickup device.

6. The image pickup apparatus according to claim 1, wherein the optical adjustment section adjusts a characteristic relating to a focus of the optical system or a focal distance of the optical system.

7. The image pickup apparatus according to claim 1, further comprising:
a setting section setting an amount by which a lens included in the optical system needs to move during the image taking,
wherein the control section performs the first adjustment and the second adjustment based on the movement amount set by the setting section.

8. The image pickup apparatus according to claim 1, wherein the control section generates the one image data by extracting, from the video signals for a plurality of images picked up by the image pickup device, a video signal captured by taking an image of the first line area corresponding to a first image and a video signal captured by taking an image of the second line area corresponding to a second image.

9. The image pickup apparatus according to claim 8, wherein in taking a plurality of images, the image pickup device picks up the first image of the subject image through the first line area and converts the subject image into the video signal, and takes the second image of the subject image through the second line area and converts the subject image into the video signal.

10. The image pickup apparatus according to claim 1, wherein the control section accumulates charges in each of the horizontal scan lines in the image pickup device with a time difference, and moves the optical system to vary a distance to the subject at which the subject is in focus, for each of the horizontal scan lines to allow image taking similar to tilt-shift image taking to be performed.

11. The image pickup apparatus according to claim 10, wherein when accumulation start time for a first one of the horizontal scan lines is defined as t0, accumulation end time for a final horizontal scan line is defined as tn, a distance between the first horizontal scan line and the final horizontal scan line on an image formation surface of the image pickup device is defined as L, and an amount by which the image formation surface of the image pickup device is moved is defined as df, the one image data is generated which has a tilt-shift angle θ expressed by:
θ=tan⁻¹(df/L).

12. A image pickup control method for an image pickup apparatus, the method comprising:
when an image of a subject formed by an optical system is picked up using an image pickup device,
accumulating charges obtained upon receiving light for the subject image, with a time difference for each scan line in the image pickup device, and modifying a characteristic of the optical system to change a distance to the subject at which the image pickup device is in focus, for each horizontal scan line.
